(19) United States
(12) Patent Application Publication
(10) Pub. No.: US 2006/0014925 A1
(43) Pub. Date: Jan. 19, 2006

(54) Method for delivery of formaldehyde-free resins

(76) Inventors: Michael William Luka, Littleton, CO (US); Michael William Miks, Littleton, CO (US)

Correspondence Address: JOHNS MANVILLE;Legal Department, 10100 West Ute Avenue, Littleton, CO, 80127, US

(21) Appl. No.: 10/891,606

(22) Filed: Jul. 15, 2004

(51) Int. Cl. C08F 6/00

(52) U.S. Cl. 528/503

(57) ABSTRACT

A method for delivering and processing a formaldehyde-free resin at a facility. The method maintains the resin slurry at a minimum temperature throughout storage of the resin slurry and use of the resin slurry to prepare a binder composition at a make up site. Maintaining the resin slurry at or above a minimum temperature ensures that a minimum viscosity is maintained to permit the proper flow of the resin slurry. The method utilizes external heat sources in conjunction with storage and transport systems to ensure that a minimum temperature is maintained.

### TECHNICAL FIELD

The present invention generally relates to a system and method which facilitates the application of a formaldehyde-free binder to glass fibers in a cost-effective manner. More particularly, the subject invention pertains to maintaining a resin useful in the preparation of binder systems at a minimum temperature throughout delivery and storage of the resin at a facility. Maintaining the resin at or above a minimum temperature throughout the process helps ensure a sufficiently low resin viscosity such that it may be pumped or otherwise manipulated through the process efficiently.

### BACKGROUND OF THE INVENTION

Fiberglass binders have a variety of uses ranging from stiffening applications where the binder is applied to woven or non-woven fiberglass sheet goods and cured, producing a stiffer product; thermo-forming applications wherein the binder composition is applied to sheet or lofty fibrous product following which it is dried and optionally B-staged to form an intermediate but yet curable product; and to fully cured systems such as building insulation.

Fibrous glass insulation products generally comprise matted glass fibers bonded together by a cured thermoset polymeric material. Molten streams of glass are drawn into fibers of random lengths and blown into a forming chamber where they are randomly deposited as a mat onto a traveling conveyor. The fibers, while in transit in the forming chamber and while still hot from the drawing operation, are sprayed with an aqueous binder. In the past, a phenol-formaldehyde binder was used throughout the fibrous glass insulation industry. The residual heat from the glass fibers and the flow of air through the fibrous mat during the forming operation are generally sufficient to volatilize the majority, to all, of the water from the binder, thereby leaving the remaining components of the binder on the fibers as a viscous or semi-viscous high solids liquid. The coated fibrous mat is transferred to a curing oven where heated air, for example, is blown through the mat to cure the binder and rigidly bond the glass fibers together.

Fiberglass binders used in the present sense should not be confused with matrix resins which are an entirely different and non-analogous field of art. While sometimes termed “binders,” matrix resins act to fill the entire interstitial space between fibers, resulting in a dense, fiber reinforced product where the matrix must translate the fiber strength properties to the composite, whereas “binder resins” as used herein are not space-filling, but rather coat only the fibers, and particularly the junction of fibers. Fiberglass binders also cannot be equated with paper or wood product “binders” where the adhesive properties are tailored to the chemical nature of the cellulosic substrates. Many such resins, e.g. urea/formaldehyde and resorcinol/formaldehyde resins, are not suitable for use as fiberglass binders. One skilled in the art of fiberglass binders would not look to cellulosic binders to solve any of the known problems associated with fiberglass binders.

Binders useful in fiberglass insulation products generally require a low viscosity in the uncured state, yet characteristics so as to form a rigid thermoset polymeric mat for the glass fibers when cured. A low binder viscosity in the uncured state is required to allow the mat to be sized correctly. Also, viscous binders tend to be tacky or sticky and hence they lead to accumulation of fiber on the forming chamber walls. This accumulated fiber may later fall onto the mat causing dense areas and product problems. A binder which forms a rigid matrix when cured is required so that a finished fiberglass thermal insulation product, when compressed for packaging and shipping, will recover to its specified vertical dimension when installed in a building.

From among the many thermosetting polymers or resins, numerous candidates for suitable thermosetting fiberglass binder resins exist. However, binder-coated fiberglass products are often of the commodity type, and thus cost becomes a driving factor, generally ruling out such resins as thermosetting polyurethanes, epoxies, and others. Due to their excellent cost/performance ratio, the resins of choice in the past have been phenol/formaldehyde resins. Phenol/formaldehyde resins can be economically produced, and can be extended with urea prior to use as a binder in many applications. Such urea-extended phenol/formaldehyde binders have been the mainstay of the fiberglass insulation industry for years.

Over the past several decades, however, minimization of volatile organic compound emissions (VOCs) both on the part of the industry desiring to provide a cleaner environment, as well as by federal regulation, has led to extensive investigations into not only reducing emissions from the current formaldehyde-based binders, but also into candidate replacement binders. For example, subtle changes in the ratios of phenol to formaldehyde in the preparation of the basic phenol/formaldehyde resole resins, changes in catalysts, and addition of different and multiple formaldehyde scavengers, has resulted in considerable improvement in emissions from phenol/formaldehyde binders as compared with the binders previously used. However, with increasingly stringent federal regulations, more and more attention has been paid to alternative binder systems which are free from formaldehyde.

One such candidate binder system employs polymers or resins of acrylic acid as a first component, and a polyol such as glycerine or a modestly oxyalkylated glycerine as a curing or “crosslinking” component. The preparation and properties of such poly(acrylic acid)-based binders, including information relative to the VOC emissions, and a comparison of binder properties versus urea formaldehyde binders is presented in “Formaldehyde-Free Crosslinking Binders For Non-Wovens,” Charles T. Arkins et al., TAPPI JOURNAL, Vol. 78, No. 11, pages 161-168, November 1995. The binders disclosed by the Arkins article, appear to be B-stageable as well as being able to provide physical properties similar to those of urea/formaldehyde resins. Unfortunately, urea/formaldehyde resins do not in general offer the same properties as phenol/formaldehyde resins, the most widely used fiberglass insulation binder resins.

One particularly useful formaldehyde-free binder system employs a binder comprising a polycarboxy polymer and a polyol. Formaldehyde-free resins are those which are not made with formaldehyde or formaldehyde-generating compounds. Formaldehyde-free resins do not emit appreciable levels of formaldehyde during the insulation manufacturing process and do not emit formaldehyde under normal service conditions. Use of this binder system in conjunction with a catalyst, such as an alkaline metal salt of a phosphorous-containing organic acid, results in glass fiber products that exhibit excellent recovery and rigidity properties.

U.S. Pat. No. 6,331,350 discloses a formaldehyde-free binder comprising a polycarboxy polymer, a polyol and a catalyst, such as an alkaline metal salt of a phosphorus-containing organic acid. This binder is formaldehyde-free, exhibits good recovery and rigidity, and allows one to prepare fiberglass insulation products with minimal processing difficulties. One processing difficulty in particular, though, deals with the high viscosity of the resin when it is supplied as a resin slurry which contains a high solids content.

Formaldehyde-free resins are typically produced at a site different than that at which they are used to produce binder slurries that are applied to glass fibers. They are transported as a slurry to the facility at which they will be applied to the glass fibers, and stored in a vessel such as a storage tank until they are used to make the binder composition that is ultimately applied to the product. Further, even where a resin is made at the same plant at which it is used, it is often necessary to store the resin slurry in a vessel prior to application.

To reduce costs associated with transporting and storing formaldehyde-free resin slurries, it is desirable for a resin slurry to have a high solids level. A high solids level resin slurry allows for more resin within a smaller volume than a lower solids suspension. One problem, though, with maintaining a high solids level in the resin slurry is that processing the resin slurry at the facility in which it is applied to the product becomes difficult and costly. High solid levels make the resin slurry more viscous, and more energy is required to pump or otherwise maneuver the resin slurry through the process. Further, viscous resin slurries tend to be tacky or sticky and hence they lead to accumulation of resin within the process piping, hampering the ability to operate efficiently.

The viscosity in high solid-level resin slurries increases dramatically with decreasing temperature, further hampering the ability of storage and process equipment to operate efficiently. Thus, the problems associated with high resin slurry viscosity are amplified in facilities located in cold-weather climates.

### BRIEF SUMMARY OF THE INVENTION

Formaldehyde-free binders used to coat glass fiber products are typically sprayed onto the product in the form of an aqueous slurry. Usually, a concentrated slurry containing a formaldehyde-free resin used to make the binder composition is produced elsewhere and delivered to the glass product facility in a delivery vessel. In order to reduce transportation costs, it is desirable to maintain a high solids content in the resin slurry. However, a high solids content results in a high slurry viscosity, making it difficult to operate the process of pumping the resin slurry to an application site where it will be used to make the binder composition for application to a glass fibers product. Thus, there is a need to maintain a high solids content in the resin slurry that is delivered to the facility, while still maintaining a low viscosity so that the process may operate as efficiently as possible.

An effective method of maintaining a high solids content and low viscosity is by maintaining the resin slurry at or above a minimum temperature throughout delivery, storage and process of using the resin slurry to prepare a binder composition. Raising the slurry temperature to a desirable level allows the slurry to be efficiently manipulated throughout the process.

Therefore, the present invention maintains a high solids level in a formaldehyde-free resin slurry, while at the same time maintaining the resin slurry at a low viscosity such that the resin slurry may be easily pumped or otherwise manipulated throughout the process of preparing a binder composition to be applied to a glass fibers product at a facility. Viscosity is maintained by keeping the resin slurry at or above a minimum temperature, the resin slurry having a maximum viscosity at the minimum temperature.

The present invention also maintains a formaldehyde-free resin slurry at or above a minimum temperature, with the resin slurry having a maximum viscosity at the minimum temperature, such that the resin slurry may be efficiently pumped or otherwise manipulated through the process of preparing a binder composition to be applied to a glass fibers product at a facility regardless of the solids level in the resin slurry.

The present invention further maintains a formaldehyde-free resin slurry at or above a minimum temperature, with the resin slurry having a maximum viscosity at the minimum temperature, such that the resin slurry may be efficiently pumped or otherwise manipulated through a process of applying it to glass fibers at a facility regardless of the atmospheric temperature at the facility's location.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a diagram of the process of using a formaldehyde-free resin slurry to prepare a binder composition to be applied to a glass fibers product at a facility;

FIG. 2 is a plot of viscosity versus temperature for a formaldehyde-free resin slurry at four different solids levels.

### DETAILED DESCRIPTION OF THE INVENTION

The invention relates to a method for maintaining a formaldehyde-free resin slurry at or above a minimum temperature throughout the delivery and storage of a product at a facility. The method is particularly useful for the delivery and storage of formaldehyde-free resins used to prepare binder compositions which are applied to glass fibers products. As used herein the term formaldehyde-free means that the resin or binder is substantially free of formaldehyde and/or does not liberate formaldehyde as a result of drying or curing.

Formaldehyde-free resins used to prepare binder compositions typically arrive at an application facility in the form of an aqueous slurry of approximately 43 to 53 Wt. % solid polymer. To minimize costs associated with transporting a resin slurry to a facility, it is desirable to maintain a high solids content in the resin slurry such that a large amount of resin slurry may be transported within a small volume. However, a high solids level in the resin slurry results in a high resin slurry viscosity. Even more problematic, a very small increase in solids level often results in a relatively large increase in the viscosity of the resin slurry. A high viscosity makes it difficult and costly, or perhaps even infeasible, to process the resin slurry and use it to prepare a binder composition.

It is thus desirable to maintain a high solids content in a resin slurry while at the same time maintaining the resin slurry at a viscosity sufficiently low such that it may be efficiently pumped or otherwise manipulated through the process of delivery, storage and use of the slurry to prepare a binder composition to be applied to a glass fibers product.

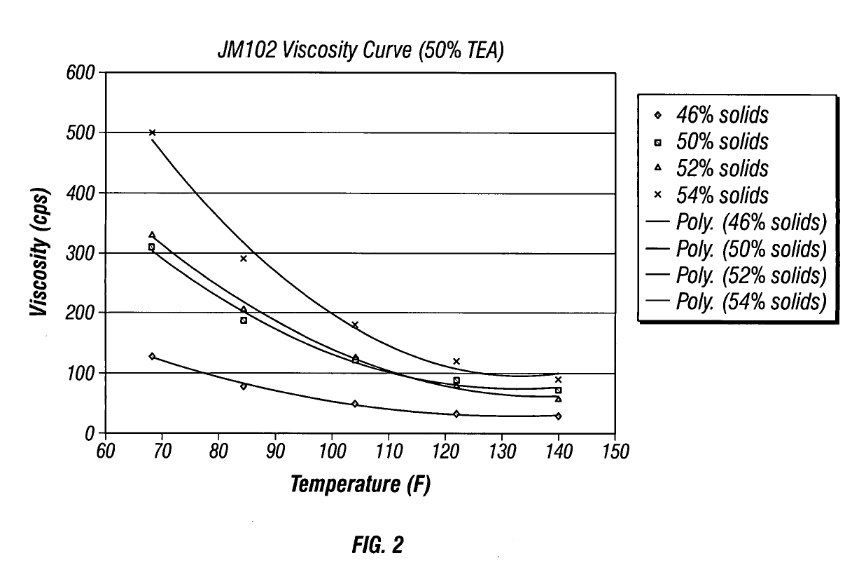

The maximum viscosity will depend upon several factors, such as the type of resin used, the solids content of the resin slurry, and the capacity of the process equipment to pump or otherwise manipulate the resin slurry through the process. Generally, it is desirable to maintain the resin slurry at or below about 300 centipoise (cps), with a viscosity at or below about 100 cps being preferred. The temperature required to maintain the resin slurry at the desired viscosity depends largely upon the solids content of the slurry as depicted in FIG. 2. Typically, the resin slurry should be maintained at or above about 20° C. (70° F.), though it is most preferable to maintain the slurry at or above about 38° C. (100° F.).

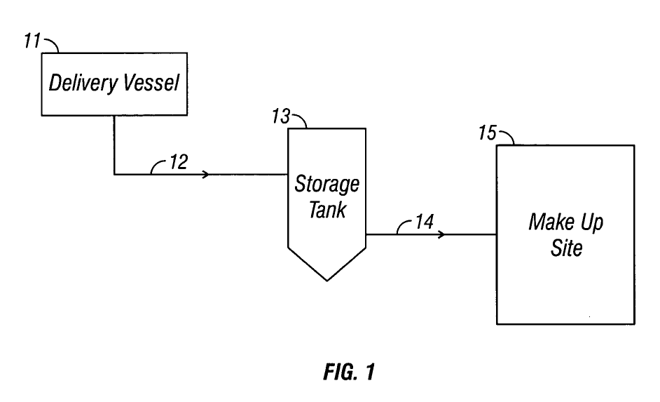

Referring now to FIG. 1, the resin slurry arrives at the facility in a delivery vessel 11. Using an unload line 12, it is transferred to a storage tank 13. From the storage tank 13, it is transferred via another unload line 14 to the make up site 15, where it is used to form a binder composition.

In one embodiment of the invention, the resin slurry is delivered to the facility at or below a maximum viscosity level. Generally, delivering the resin slurry at a minimum temperature of 20° C. (70° F.) may suffice, though it is preferable to deliver the resin slurry at a temperature of at least 38° C. (100° F.). However, the minimum temperature required to maintain the viscosity at a desired level depends largely on the type of resin and the amount of solids contained in the resin composition.

The resin slurry is then maintained at or below the maximum viscosity while in the storage tank 13 by maintaining it at or above the minimum required temperature. This can be accomplished in several ways. One method of maintaining the minimum temperature in the tank is to add heat to the resin slurry in the tank. While any method of adding heat may be used, a preferred method utilizes an electric heating element to add heat. Use of a suitable electric heating element allows for addition of sufficient heat to maintain the resin slurry at a minimum temperature, regardless of the climate at the facility's location. An example of a heating element that may be used is a Flexwatt tank heating system. The Flexwatt system utilizes either a single heating element or a plurality of heating elements, depending on the temperature requirements. Depending on the number of elements installed and the type and amount of insulation, if any, used in the tank, Flexwatt systems can maintain temperatures up to about 80° C. (170° F.).

Other methods of adding heat to a resin slurry in the storage tank 13 include use of a steam jacket or hot water jacket if either is available and feasible. Hot air or even solar heating may also be utilized as a heating source, depending on climate at the facility's location, the solids content in the resin slurry, and other factors. These examples are merely illustrative, and not exhaustive. Any method of heating the resin slurry may be employed.

A mixing device may also be included inside the storage tank 13, either alone or in combination with heating the binder in some manner. In facilities located in cold-weather climates, a mixing device within the tank alone may not be sufficient to maintain the resin slurry at or above the minimum temperature. Using both a mixing device and a heater may also effectively raise the temperature of the resin slurry to the minimum temperature if the binder is delivered below the minimum temperature. In these facilities, some type of heating element may be necessary. If the resin slurry is delivered at or above the minimum temperature, particularly at those facilities located in warm-weather climates and those at which the binder is stored in the storage tank 13 for a very short period of time, a mixing device by itself may be sufficient to maintain the resin slurry at or above the minimum temperature.

Another way to maintain the minimum temperature of the stored resin slurry is by insulating the storage tank 13. One example of insulation that may be used in the tank is Manville Micro Flex Tank Wrap with an AP Jacket. Insulation may be sufficient to maintain the minimum temperature and maximum viscosity, particularly in facilities located in warm weather climates. However, insulation of the storage tank 13 may not be sufficient to maintain the minimum temperature in the tank. This holds especially true at facilities located in cold weather climates, or in situations in which the resin slurry is stored in the tank for a long period of time. Such cases may require use of a heating element.

The resin slurry is then unloaded from the storage tank 13 and transferred to the make up site 15. The resin slurry may be transported to the make up site 15 through a pipe. The temperature of the resin slurry should be maintained at or above the minimum temperature throughout transfer to the make up site 15. A preferred method of maintaining the minimum temperature in the pipe is by adding heat to the resin slurry in the pipe. One suitable method for adding heat to the binder in the pipe is by “heat tracing” the pipe. Alternatively, the pipe may be insulated sufficiently such that the resin slurry remains at or above the minimum temperature throughout the process, until it is used to prepare a binder composition to be applied to a product.

Selection of an efficient method for maintaining the resin slurry at or above the minimum temperature inside the pipe depends on the atmospheric temperature surrounding the pipe and the length of time the resin slurry spends in the pipe before reaching the make up site. For example, in warm climates, simply insulating the pipe may be sufficient to maintain the resin slurry at or above the minimum temperature. Similarly, if the distance between the storage tank 13 and the make up site 15 is relatively short and the transfer time between the storage tank 13 and the make up site 15 is small, insulation may be sufficient. However, in cold weather climates and in situations in which the resin slurry spends a large amount of time within the pipe, insulation may be insufficient to maintain the minimum temperature. In these situations, it may be necessary to add heat to the resin slurry inside the piping.

In another embodiment of the invention, the resin slurry may be delivered to the facility at a temperature significantly higher than the minimum temperature. It may then be unnecessary to add heat to the resin slurry during the storage of the resin slurry and transportation of the resin slurry from the storage tank 13 to the make up site 15. Whether this embodiment can successfully maintain the resin slurry at or above the minimum temperature depends on the initial temperature at which the resin slurry is delivered, the climate in the facility's location, and the amount of time the resin slurry spends in the storage tank 13 and piping before reaching the make up site 15. In cold weather climates or in situations in which the resin slurry remains in the storage tank 13 and/or piping for a long period of time, this embodiment may not be suitable for practicing the invention. Rather, it will generally be necessary to use a heating element to maintain proper viscosity in cold weather.

In another embodiment of the invention, maintenance of a low viscosity is independent of the temperature at which the resin slurry is delivered. In this embodiment, the storage tank 13 may include an internal or external heating element sufficient to heat the resin slurry within the tank to at least the desired minimum temperature, regardless of delivery temperature. The heating element may also be used in conjunction with a mixing element in the tank. The resin slurry is then maintained at or above the minimum temperature throughout the remainder of the process.

A method typically used in practicing the invention is as follows. The resin slurry is delivered to a facility at or above 38° C. The resin slurry is unloaded from the delivery vessel 11, generally a truck, via an unload line 12 and transported to a storage tank 13. The unload line 12 is heat traced and insulated sufficiently to maintain the resin slurry at or above 38° C. while it is transferred to the storage tank 13. The storage tank 13 includes a heating element sufficient to maintain the resin slurry at or above 38° C. during the time it is stored. The resin slurry is then transferred from the storage tank 13 to a make up site 15 via a pipe. The pipe is heat traced and insulated sufficiently to maintain the resin slurry at or above 38° C. until it reaches the make up site 15 and is used to form a binder composition.

FIG. 2 displays a plot of viscosity versus temperature for a formaldehyde-free resin slurry at different levels of solids content. It makes clear that the required minimum temperature for achieving a viscosity at or below a chosen maximum level varies significantly with slight changes in solids content. For example, to lower the viscosity of the resin slurry with a solids content of 54% to 300 cps, the resin slurry must be heated to about 31° C. (87° F.). By contrast, the same resin slurry having a solids content of 46% has a viscosity of well below 300 cps even at the lowest temperature shown on the plot, about 20° C. (68° F.). To maintain a preferred viscosity level of 100 cps or lower, the resin slurry having a 54% solids content must be heated to about 56° C. (133° F.). The resin slurry having a 46% solids level can be maintained at or below 100 cps at a much lower temperature of about 26° C. (78° F.).

Comparisons of other solids contents yield different results but illustrate the same point. Relatively small increases in solids levels in the resin slurry result in a much higher resin slurry temperature requirement for achieving a desired viscosity level.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method of delivering and storing a formaldehyde-free resin slurry at a facility, the method comprising:
(a) delivering a formaldehyde-free resin slurry contained in a vessel to a facility, the resin slurry being delivered at or above a minimum temperature sufficient to maintain the viscosity of the resin slurry at a level sufficiently low to permit flow through the system;
(b) unloading the resin slurry from the vessel using an unload line while maintaining the resin slurry in the unload line at or above the minimum temperature;
(c) transporting the resin slurry in the unload line to a storage tank while maintaining the resin slurry in the unload line at or above the minimum temperature;
(d) unloading the resin slurry from the storage tank using an unload line while maintaining the resin slurry in the unload line at or above the minimum temperature; and
(e) transporting the resin slurry in the unload line to a make up site while maintaining the resin slurry in the unload line at or above the minimum temperature.

2. The method of claim 1, wherein the viscosity of the resin slurry at the minimum temperature is less than about 300 centipoise.

3. The method of claim 1, wherein the viscosity of the resin slurry at the minimum temperature is less than about 200 centipoise.

4. The method of claim 1, wherein the viscosity of the resin slurry at the minimum temperature is less than about 100 centipoise.

5. The method of claim 1, wherein the minimum temperature is at least about 20° C.

6. The method of claim 1, wherein the minimum temperature is at least about 25° C.

7. The method of claim 1, wherein the minimum temperature is at least about 30° C.

8. The method of claim 1, wherein the unload line includes insulation and heat tracing.

9. A method of delivering and storing a formaldehyde-free resin slurry at a facility, the method comprising:
(a) delivering a formaldehyde-free resin slurry contained in a vessel to a facility;
(b) unloading the resin slurry from the vessel using an unload line;
(c) transporting the resin slurry in the unload line to a storage tank;
(d) adding sufficient heat to the resin slurry in the storage tank to increase the resin slurry to a minimum temperature sufficient to maintain the viscosity of the resin slurry at a level sufficiently low to permit flow through the system;
(e) unloading the resin slurry from the storage tank using an unload line while maintaining the resin slurry in the unload line at or above the minimum temperature; and
(f) transporting the resin slurry in the unload line to a make up site while maintaining the resin slurry in the unload line at or above the minimum temperature.

10. The method of claim 9, wherein the storage tank includes an electric heating element.

11. The method of claim 10, wherein the heating element is used in conjunction with a mixing element to heat the binder.

12. The method of claim 9, wherein the viscosity of the binder at the minimum temperature is less than about 300 centipoise.

13. The method of claim 9, wherein the viscosity of the binder at the minimum temperature is less than about 200 centipoise.

14. The method of claim 9, wherein the viscosity of the binder at the minimum temperature is less than about 100 centipoise.

15. The method of claim 9, wherein the minimum temperature is at least about 20° C.

16. The method of claim 9, wherein the minimum temperature is at least about 25° C.

17. The method of claim 9, wherein the minimum temperature is at least about 30° C.

18. A method of delivering and storing a formaldehyde-free resin at a facility, the method comprising delivering a resin slurry contained in a vessel to a facility, the resin slurry being delivered at a sufficiently high temperature such that the resin slurry never falls below a minimum temperature throughout storage, the resin slurry having a sufficiently low viscosity at the minimum temperature to permit flow through the system.

19. The method of claim 18, wherein the viscosity of the resin slurry at the minimum temperature is less than about 300 centipoise.

20. The method of claim 18, wherein the viscosity of the resin slurry at the minimum temperature is less than about 200 centipoise.

21. The method of claim 18, wherein the viscosity of the resin slurry at the minimum temperature is less than about 100 centipoise.

22. The method of claim 18, wherein the minimum temperature is at least about 20° C.

23. The method of claim 18, wherein the minimum temperature is at least about 25° C.

24. The method of claim 18, wherein the minimum temperature is at least about 30° C.
